(19) United States
(12) Patent Application Publication
(10) Pub. No.: US 2008/0027939 A1
(43) Pub. Date: Jan. 31, 2008

(54) METHOD, SYSTEM, AND PROGRAM PRODUCT FOR CONTROLLING ACCESS TO PERSONAL ATTRIBUTES ACROSS ENTERPRISE DOMAINS

(76) Inventors: Nanchariah R. Chalasani, Fairfax, VA (US); Jiayue Chen, Plano, TX (US); Jacob D. Eisinger, Austin, TX (US); Josephine R. Gordon, Austin, TX (US); David G. Kuehr-McLaren, Apex, NC (US); Nataraj Nagaratnam, Morrisville, NC (US); Luke T. Rajlich, Champaign, IL (US)

Correspondence Address: HOFFMAN WARNICK & DALESSANDRO LLC, 75 STATE ST, 14TH FLOOR, ALBANY, NY, 12207, US

(21) Appl. No.: 11/461,038

(22) Filed: Jul. 31, 2006

(51) Int. Cl. G06F 17/30

(52) U.S. Cl. 707/9

(57) ABSTRACT

In general, the present invention provides a method, system, and program product for managing personal attributes across enterprise domains. Specifically, under the present invention, personal attributes for an end-user will be located among the enterprise domains. Once located, the personal attributes will be grouped into a set of profiles based on associated services (e.g., medical, insurance, etc.). The end-user can log into the system to see his/her personal attributes and to provide input regarding how access to the personal attributes should be controlled. Specifically, based on the end-user's input (and possibly other factors such as applicable legislation) an access control policy will be generated and used to control access to the personal attributes. In addition, any transactions involving the personal attributes will be recorded so that auditing can take place.

### BACKGROUND OF THE INVENTION

1. Field of the Invention

The present invention is generally related to personal attribute management. Specifically, the present invention provides a method, system, and program product for managing personal attributes across enterprise domains.

2. Related Art

Federated identity is an important technology that promises to provide secured trust relationships for businesses and individuals in e-business. Federated identity can promote new forms of enhanced service by which businesses can offer consumers more robust services based on identity information of the end consumer. Existing specifications for federated identity include Liberty Alliance and WS-Federation. Current implementations of federated identity have been focusing on business level control of personal information.

Unfortunately, no method has been defined to enable the end-user to view and control his/her identity attributes in the federation. The regulations on the use of personal information are becoming more complex, often requiring involvement of the end-user. Additionally, consumers are less willing to trust services based on federated identity without visibility of their own identity information. Without user awareness and confidence in federated identity, businesses cannot expand beyond their current barriers and fully take advantage of the greater opportunities offered by this enhanced trust environment.

In view of the foregoing, there exists a need for an approach that solves at least one of the deficiencies in the related art.

### SUMMARY OF THE INVENTION

In general, the present invention provides a method, system, and program product for managing personal attributes across enterprise domains. Specifically, under the present invention, personal attributes for an end-user will be located among the enterprise domains. Once located, the personal attributes will be grouped into a set of profiles based on associated services (e.g., medical, insurance, etc.). The end-user can log into the system to see his/her personal attributes and to provide input regarding how access to the personal attributes should be controlled. Specifically, based on the end-user's input (and possibly other factors such as applicable legislation) an access control policy will be generated and used to control access to the personal attributes. In addition, any transactions involving the personal attributes will be recorded so that auditing can take place.

A first aspect of the present invention provides a method for controlling access to personal attributes across enterprise domains, comprising: locating the personal attributes among the enterprise domains; organizing the personal attributes into a set of profiles based on associated services; obtaining at least one access control policy governing sharing of the personal attributes; and controlling access to the personal attributes based on the at least one access control policy.

A second aspect of the present invention provides a system for controlling access to personal attributes across enterprise domains, comprising: an attribute discovery system for locating the personal attributes among the enterprise domains; an attribute organization system for organizing the personal attributes into a set of profiles based on associated services; an access control system for generating at least one access control policy governing sharing of the personal attributes; and a policy enforcement system for controlling access to the personal attributes based on the at least one access control policy.

A third aspect of the present invention provides a program product stored on a computer readable medium for controlling access to personal attributes across enterprise domains, the computer readable medium comprising program code for causing a computer system to perform the following steps: locating the personal attributes among the enterprise domains; organizing the personal attributes into a set of profiles based on associated services; obtaining at least one access control policy governing sharing of the personal attributes; and controlling access to the personal attributes based on the at least one access control policy.

A fourth aspect of the present invention provides a method for deploying an application for controlling access to personal attributes across enterprise domains, comprising: providing a computer infrastructure being operable to: locate the personal attributes among the enterprise domains; organize the personal attributes into a set of profiles based on associated services; obtain at least one access control policy governing sharing of the personal attributes; and control access to the personal attributes based on the at least one access control policy.

A fifth aspect of the present invention provides computer software embodied in a propagated signal for controlling access to personal attributes across enterprise domains, the propagated signal comprising instructions for causing a computer system to perform the following steps: locating the personal attributes among the enterprise domains; organizing the personal attributes into a set of profiles based on associated services; obtaining an access control policy governing sharing of the personal attributes; and controlling access to the personal attributes based on the access control policy.

A sixth aspect of the present invention provides a business method controlling access to personal attributes across enterprise domains.

Therefore, the present invention provides a method, system, and program product for controlling access to personal attributes.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for viewing and controlling access to personal attributes in accordance with the present invention.

FIG. 2 depicts an illustrative interface for associating personal attributes with services and generating access control policies in accordance with the present invention.

FIG. 3 depicts the association of access control policies with enterprise domains in accordance with the present invention.

FIG. 4 depicts a more detailed diagram of a computerized system for controlling access to personal attributes according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention has the following sections:

I. General Description

II. Computerized Implementation

### I. General Description

As indicated above, the present invention provides a method, system, and program product for managing personal attributes across enterprise domains. Specifically, under the present invention, personal attributes for an end-user will be located among the enterprise domains. Once located, the personal attributes will be grouped into a set of profiles based on associated services (e.g., medical, insurance, etc.). The end-user can log into the system to see his/her personal attributes and to provide input regarding how access to the personal attributes should be controlled. Specifically, based on the end-user's input (and possibly other factors such as applicable legislation) an access control policy will be generated and used to control access to the personal attributes. In addition, any transactions involving the personal attributes will be recorded so that auditing can take place.

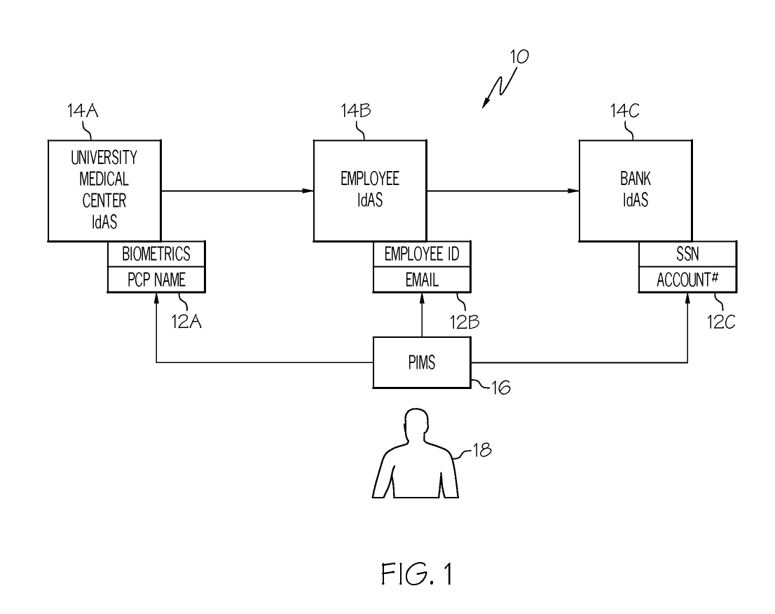

Referring now to FIG. 1, a system 10 for controlling access to personal attributes 12A-C over enterprise domains 14A-C is shown. Specifically, system 10 includes a Personal Identity Management System (PIMS) 16 that allows an end-user 18 to control access to his/her identifying information 12A-C or personal attributes as referred to herein. Examples of personal attributes 12A-C shown in FIG. 1 include biometric information, primary care physician (PCP) information, employee identification, email information, social security number, and account information.

Under the present invention, PIMS 16 will first locate the personal attributes 12A-C of user 18 that are distributed across enterprise domains 14A-C. In general, enterprise domains 14A-C are maintained by service providers utilized by end-user 18. For example, enterprise domains 14A-C are maintained by a university medical center, an employer, and a bank of end-user 18, respectively. As further shown, enterprise domains 14A-C can each include an identity attribute system (iDAS as known in the art) that store the personal attributes or any system(s) that act in a similar way to an iDAS, such as a service that provides information to requesters about an entity such as a personal business. Along these lines, PIMS 16 could locate the personal attributes by querying the iDAS. Regardless, once the personal attributes 12A-C are located, PIMS 16 will organize the same into profiles based on the associated services (e.g., an insurance policy number can be linked with healthcare services). Using PIMS 16, end-user 18 can view personal attributes 12A-C and make decisions about whether to share particular attributes 12A-C based on the desired services. These choices will then be translated by PIMS 16 into one or more access control policies that govern the sharing of personal attributes 12A-C.

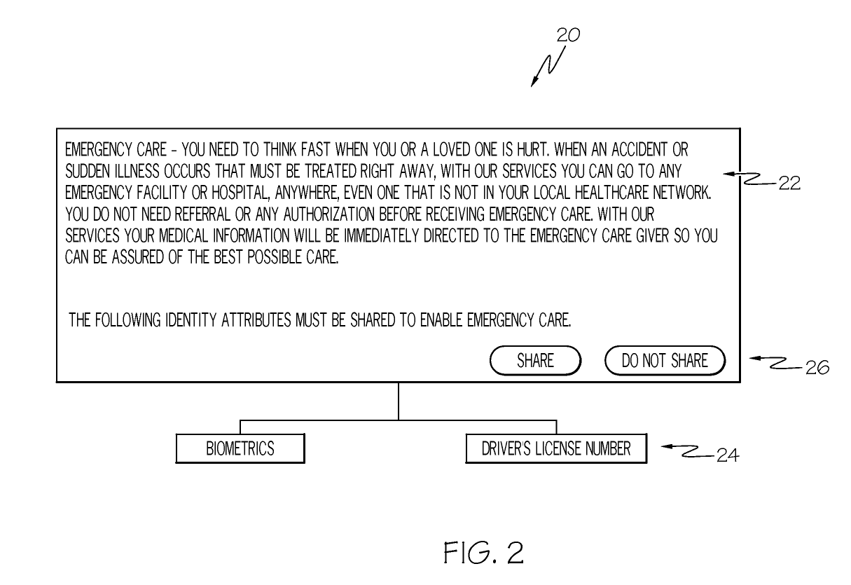

Referring now to FIG. 2, an illustrative interface 20 for associating personal attributes 12A-C with services/enterprise domains 14A-C and generating access control policies in accordance with the present invention. As shown, interface 20 provides a description 22 of a particular service, personal attributes 24 to be selected for sharing with the service, and a mechanism 26 for making a deliberate selection of whether to share the personal attributes 24. The personal attributes 24 are associated with the service 22 in the policy. Therefore, if the policy is chosen, the attributes 24 are only accessible in the context of the service 22 as described. The choices and selections made using interface 20 will be turned into one or more access control policies that are associated with the corresponding enterprise domains' 14A-C iDAS. It should be understood that default and mandatory supreme access authority to certain personal attributes between enterprise domains 14A-C could be included as part of the present invention (e.g., in access control policies). An example of this is medical information that could be needed to treat a user during an emergency.

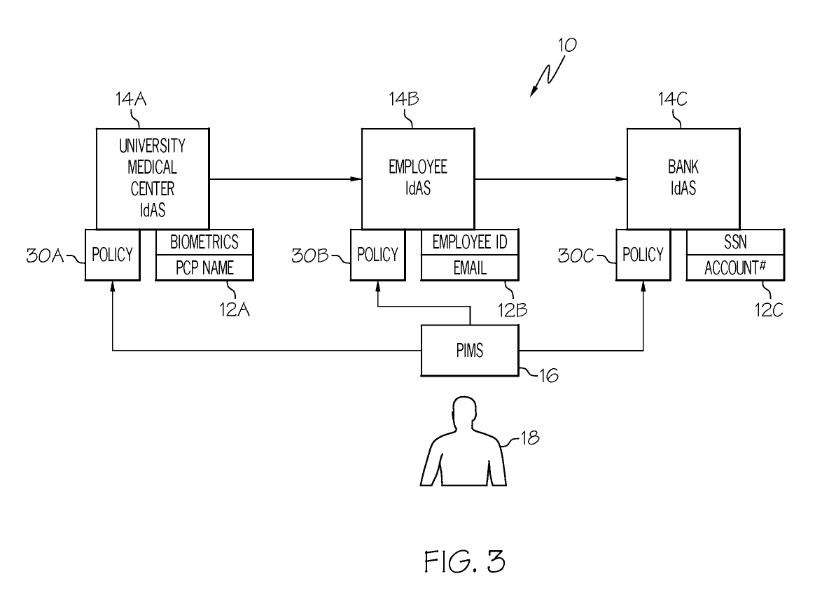

Referring to FIG. 3, the association of access control policies 30A-C with enterprise domains 14A-C is shown. In one embodiment, access control policies 30A-C can be stored in the iDAS'. Regardless of where they are stored, access control policies 30A-C will be used to control access to their respective personal attributes 12A-C. Specifically, iDAS' will evaluate all access requests for personal attributes 12A-C against their corresponding access control policies 30A-C. Any transactions involving personal attributes 12A-C will be tracked by the iDAS and transferred to PIMS 16 for recording and subsequent viewing and/or auditing (e.g., by end-user 18). It should be understood that distinct access control policies need not be provided for each enterprise domain 14A—as shown in FIG. 3. For example, a single, comprehensive access control policy could be developed that is associated with enterprise domains 14A-C.

### II. Computerized Implementation

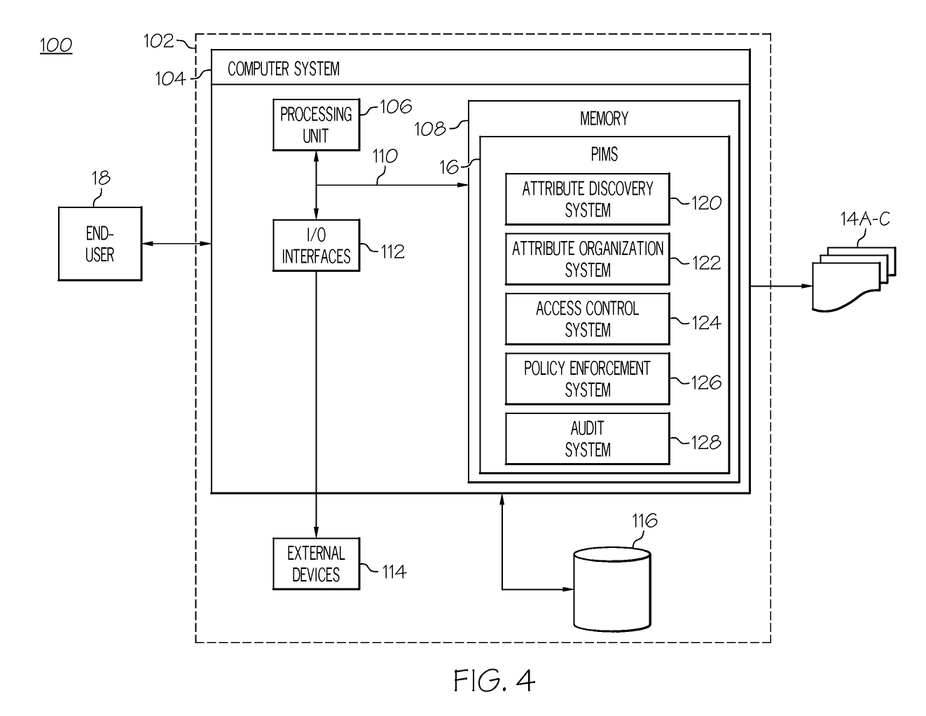

Referring now to FIG. 4, a more detailed diagram of a computerized implementation 100 of the present invention is shown. As depicted, implementation 100 includes a computer system 104 deployed within a computer implementation 102. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer implementation 102 is intended to demonstrate that some or all of the components of implementation 100 could be deployed, managed, serviced, etc. by a service provider who offers to control access to personal attributes according to the present invention.

As shown, computer system 104 includes a processing unit 106, a memory 108, a bus 110, and input/output (I/O) interfaces 112. Further, computer system 104 is shown in communication with external I/O devices/resources 114 and storage system 116. In general, processing unit 106 executes computer program code, such as PIMS 16, which is stored in memory 108 and/or storage system 116. While executing computer program code, processing unit 106 can read and/or write data to/from memory 108, storage system 116, and/or I/O interfaces 112. Bus 110 provides a communication link between each of the components in computer system 104. External devices 114 can comprise any devices (e.g., keyboard, pointing device, display, etc.) that enable a user to interact with computer system 104 and/or any devices (e.g., network card, modem, etc.) that enable computer system 104 to communicate with one or more other computing devices.

Computerized implementation 102 is only illustrative of various types of computer infrastructures for implementing the invention. For example, in one embodiment, computer implementation 102 comprises two or more computing devices (e.g., a server cluster) that communicate over a network to perform the various process steps of the invention. Moreover, computer system 104 is only representative of various possible computer systems that can include numerous combinations of hardware and/or software. To this extent, in other embodiments, computer system 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 106 may comprise a single processing unit, or be distributed across one or more processing units in one or more locations, e.g., on a client and server. Similarly, memory 108 and/or storage system 116 can comprise any combination of various types of data storage and/or transmission media that reside at one or more physical locations. Further, interfaces 112 can comprise any system for exchanging information with one or more external interfaces 114. Still further, it is understood that one or more additional components (e.g., system software, math co-processing unit, etc.) not shown in FIG. 4 can be included in computer system 104. However, if computer system 104 comprises a handheld device or the like, it is understood that one or more external interfaces 114 (e.g., a display) and/or storage system 116 could be contained within computer system 104, not externally as shown.

Storage system 116 can be any type of system (e.g., a database) capable of providing storage for information under the present invention such as selections made by end user 18, etc. To this extent, storage system 116 could include one or more storage devices, such as a magnetic disk drive or an optical disk drive. In another embodiment, storage system 116 includes data distributed across, for example, a local area network (LAN), a wide area network (WAN) or a storage area network (SAN) (not shown). In addition, although not shown, additional components, such as cache memory, communication systems, system software, etc., may be incorporated into computer system 104.

Shown in memory 108 of computer system 104 is PIMS 16, which includes an attribute discovery system 120, an attribute organization system 122, an access control system 124, a policy enforcement system 126, and an audit system 128. These systems perform the functions of the present invention as discussed above. Specifically, attribute discovery system 120 will locate the personal attributes among enterprise domains 14A-C, attribute organization system 122 will organize the personal attributes into a set of profiles based on associated services (e.g., provided by enterprise domains), access control system 124 will provide the interfaces for end-user 18 to view personal attributes and make selections regarding their access and then generate access control policies based thereon, policy enforcement system 126 will control access to the personal attributes based on the access control polices, and audit system 128 will record any transactions involving the personal attributes for viewing and/or auditing by end-user 18.

While shown and described herein as a method and system for controlling access to personal attributes across enterprise domains, it is understood that the invention further provides various alternative embodiments. For example, in one embodiment, the invention provides a computer-readable/useable medium that includes computer program code to enable a computer infrastructure to control access to personal attributes across enterprise domains. To this extent, the computer-readable/useable medium includes program code that implements each of the various process steps of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 108 (FIG. 4) and/or storage system 116 (FIG. 4) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to control access to personal attributes across enterprise domains. In this case, the service provider can create, maintain, support, etc., a computer infrastructure, such as computer implementation 102 (FIG. 4) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for controlling access to personal attributes across enterprise domains. In this case, a computer infrastructure, such as computer implementation 102 (FIG. 4), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 104 (FIG. 4), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for controlling access to personal attributes across enterprise domains, comprising:
locating the personal attributes among the enterprise domains;
organizing the personal attributes into a set of profiles based on services associated with the enterprise domains;
obtaining at least one access control policy governing sharing of the personal attributes; and
controlling access to the personal attributes based on the at least one access control policy.

2. The method of claim 1, further comprising associating the at least one access control policy with the enterprise domains.

3. The method of claim 1, further comprising recording transactions involving the personal attributes.

4. The method of claim 3, further comprising auditing the recorded transactions.

5. The method of claim 1, the personal attributes pertaining to an end-user.

6. The method of claim 1, the obtaining comprising generating the at least one access control policy based on input received from an end-user.

7. A system for controlling access to personal attributes across enterprise domains, comprising:
an attribute discovery system for locating the personal attributes among the enterprise domains;
an attribute organization system for organizing the personal attributes into a set of profiles based on services associated with the enterprise domains;
an access control system for generating at least one access control policy governing sharing of the personal attributes; and
a policy enforcement system for controlling access to the personal attributes based on the at least one access control policy.

8. The system of claim 7, wherein the access control system further associates the at least one access control policy with the enterprise domains.

9. The system of claim 7, further comprising an audit system for recording transactions involving the personal attributes.

10. The system of claim 7, the personal attributes pertaining to an end-user.

11. The system of claim 7, the at least one access control policy being defined based on input received from an end-user.

12. A program product stored on a computer readable medium for controlling access to personal attributes across enterprise domains, the computer readable medium comprising program code for causing a computer system to perform the following steps:
locating the personal attributes among the enterprise domains;
organizing the personal attributes into a set of profiles based on services associated with the enterprise domains;
obtaining at least one access control policy governing sharing of the personal attributes; and
controlling access to the personal attributes based on the at least one access control policy.

13. The program product of claim 12, the computer useable medium further comprising program code for causing the computer system to perform the following step: associating the access control policies with the enterprise domains.

14. The program product of claim 12, the computer useable medium further comprising program code for causing the computer system to perform the following step: recording transactions involving the personal attributes.

15. The program product of claim 14, the computer useable medium further comprising program code for causing the computer system to perform the following step: auditing the recorded transactions.

16. The program product of claim 12, the personal attributes pertaining to an end-user.

17. The program product of claim 12, the computer useable medium further comprising program code for causing the computer system to perform the following step: generating the at least one access control policy based on input received from an end-user.

18. A method for deploying an application for controlling access to personal attributes across enterprise domains, comprising:
providing a computer infrastructure being operable to:
locate the personal attributes among the enterprise domains;
organize the personal attributes into a set of profiles based on services associated with the enterprise domains;
obtain at least one access control policy governing sharing of the personal attributes; and
control access to the personal attributes based on the at least one access control policy.

19. The method of claim 18, the computer infrastructure being further associate the at least one access control policy with the enterprise domains.

20. The method of claim 19, the computer infrastructure being further operable to audit the recorded transactions.
